(19) United States
(12) Patent Application Publication
(10) Pub. No.: US 2026/0350674 A1
(43) Pub. Date: Nov. 5, 2026

(54) Execution Rail Licensing by Jurisdiction With Platform-Level Vendor Permission Enforcement

(71) Applicant: ADRIAN FARIAS JARAMILLO, JURUPA VALLEY, CA (US)

(72) Inventor: ADRIAN FARIAS JARAMILLO, JURUPA VALLEY, CA (US)

(21) Appl. No.: 19/336,181

(22) Filed: Sep. 22, 2025

Related U.S. Application Data
(63) Continuation of application No. 19/197,894, filed on May 2, 2025.
(60) Provisional application No. 63/786,937, filed on Apr. 10, 2025.
(60) Provisional application No. 63/787,944, filed on Apr. 13, 2025.
(60) Provisional application No. 63/788,834, filed on Apr. 15, 2025.
(60) Provisional application No. 63/791,534, filed on Apr. 20, 2025.
(60) Provisional application No. 63/792,918, filed on Apr. 23, 2025.

(51) Int. Cl. G06Q 30/0601; G06Q 10/083

(52) U.S. Cl. CPC G06Q 30/0611; G06Q 10/083

(57) ABSTRACT

A system and method for enforcing vendor execution permissions based on jurisdictional license parameters. The invention enables platform-controlled licensing by region, verifying vendor identity and regional access eligibility before fulfillment. Unauthorized vendors are denied execution, logged, and surfaced for compliance action. The system includes real-time metadata analysis, dynamic boundary enforcement, and buyer-facing notice logic.

### CROSS-REFERENCE TO RELATED APPLICATIONS

This application is a continuation of U.S. Utility patent application Ser. No. 19/197,894, filed May 2, 2025, which claims the benefit of the following U.S. Provisional Patent Applications, each of which is incorporated herein by reference in its entirety:
U.S. Provisional Application No. 63/786,937, filed Apr. 10, 2025, titled “System and Method for Buyer-Initiated Marketplace Transactions Across Multiple Industries”
U.S. Provisional Application No. 63/787,944, filed Apr. 13, 2025, titled “Sealed Toolset and Logic Framework for Buyer-Initiated Offer Systems”
U.S. Provisional Application No. 63/788,834, filed Apr. 15, 2025, titled “Toolset Protection for Modular Buyer-Initiated Offer Ecosystem”
U.S. Provisional Application No. 63/791,534, filed Apr. 20, 2025, titled “Modular Toolset Architecture for Multi-Sector Buyer-Initiated Commerce Infrastructure”
U.S. Provisional Application No. 63/792,918, filed Apr. 23, 2025, titled “Lockdown: Final Enforcement Tools for Global Buyer-Initiated Transaction Control”

### FIELD OF THE INVENTION

The present invention relates generally to commercial execution systems and, more particularly, to jurisdictional enforcement, vendor permission control, and territory-specific licensing within sealed execution rails.

### BACKGROUND OF THE INVENTION

Conventional fulfillment platforms do not restrict execution capabilities based on geographic licensing or jurisdictional enforcement, allowing vendors to operate without regard to territory-based permissions.

Current systems also lack enforcement tools to block unauthorized vendor activity in restricted territories or enforce platform-specific license issuance by geography.

There exists a need for an execution system that dynamically enforces vendor permissions and execution access based on regional, national, or platform-defined jurisdiction.

### SUMMARY OF THE INVENTION

This invention introduces a jurisdiction-locked execution rail system that ties vendor access and execution permissions to geographic or territory-based licensing rules.

Vendors cannot fulfill buyer requests unless they possess the correct license type for the designated jurisdiction.

The platform governs license issuance, revocation, and enforcement using metadata, IP tracking, location signals, and embedded vendor credential logic.

Unauthorized vendors are denied execution rights within disallowed territories and logged for compliance review.

Each fulfillment trigger is checked against jurisdictional enforcement logic before offer activation.

Buyers may receive a notice if a desired offer cannot be fulfilled due to regional restrictions, with alternate licensed vendors surfaced.

### DETAILED DESCRIPTION OF THE INVENTION

The system includes a vendor license verification engine tethered to a jurisdictional rule map.

Each vendor is assigned a license ID with parameters that define permitted geographic activity zones.

When a buyer initiates a request, the system checks the geographic origin and intended delivery location of the fulfillment.

If the vendor is not authorized for the region, the offer is denied, and alternate authorized vendors are surfaced if available.

Platform-specific controls allow selective enforcement based on internal licensing strategy, treaty compliance, or commercial boundary rules.

Jurisdictional filters are maintained and updated by platform administrators or via automated legislative feed ingestion.

Vendors may request expanded access zones by submitting compliance documentation, government permits, or platform-based performance history.

All denied fulfillment attempts are recorded, and repeat violations may result in global license suspension or metadata blacklisting.

Metadata signals include IP address, device GPS, vendor registration locale, and user-supplied documents.

License enforcement rules may vary based on sector, political restrictions, buyer risk score, or real-time compliance indicators.

What is claimed is:

1. A system comprising:
a vendor jurisdiction enforcement engine;
a territory-locked license issuance module;
and a fulfillment denial controller that blocks execution from unauthorized regions.

2. The system of claim 1, wherein the vendor jurisdiction enforcement engine includes IP geolocation, GPS data, and metadata cross-referencing.

3. The system of claim 1, wherein vendors are assigned license profiles that define geographic boundaries of execution eligibility.

4. A method comprising:
receiving a buyer request;
identifying the fulfillment location;
matching vendor license zones;
and denying execution if region is unauthorized.

5. The system of claim 1, further comprising a dynamic rules engine that updates enforcement boundaries based on new jurisdictional inputs.

6. The method of claim 4, wherein denied offers are logged and vendor violation frequency is tracked.

7. The system of claim 1, wherein vendor license requests are approved or denied based on submitted compliance documents or government permits.

8. A system wherein buyers are notified of jurisdiction-based execution blocks and shown alternative compliant vendors.

9. The method of claim 4, wherein a fulfillment transaction is paused until license status is confirmed for cross-border deliveries.

10. The system of claim 1, wherein metadata blacklisting is used to block vendors from bypassing regional restrictions.

11. The system of claim 1, wherein license revocation is triggered by policy updates or legislative rule changes.

12. A method comprising:
tracking vendor fulfillment history;
adjusting license parameters;
and enforcing suspension based on violation patterns.

13. The system of claim 1, wherein fulfillment triggers from disallowed jurisdictions are quarantined for manual review.

14. The method of claim 4, wherein license issuance is tethered to vendor tier, history, and regional compliance performance.

15. A jurisdiction-filtered execution control system comprising:
region-aware license issuance, metadata analysis, and platform-defined enforcement parameters.

16. The system of claim 1, wherein territory-specific execution zones are updated using automated external compliance feeds.

17. A system comprising:
a buyer request router, a vendor permission validator, and a denial logger that tracks unauthorized attempts.

18. The system of claim 1, wherein platform administrators may override geographic restrictions in emergency cases.

19. A compliance engine comprising:
jurisdictional rule maps, vendor tier classification, and cross-border fulfillment filters.

20. The system of claim 1, wherein region-locked license tokens are required for execution access and verified at runtime.
